(19) United States
(12) Patent Application Publication
(10) Pub. No.: US 2009/0025617 A1
(43) Pub. Date: Jan. 29, 2009

(54) SYSTEM OF ACCESSORIES FOR MODEL TRAIN TABLE

(76) Inventor: Frederick H. Brown, Glenburn, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 11/781,731

(22) Filed: Jul. 23, 2007

(51) Int. Cl. A47B 13/08; A63H 33/42; E01B 23/00; G09F 7/00

(52) U.S. Cl. 108/153.1; 238/10 E; 40/584; 446/87

(57) ABSTRACT

A system of accessories to be used with a model train table having raised sides, said system comprising at least one perimeter section having a top member, an inner panel, and an outer panel, whereby the perimeter members are suitably adapted to be placed over and onto the sides of the model train table, such that portions of model train track may be placed onto the top members of the perimeter sections and graphic designs may be placed onto the outer faces of the panels of the perimeter sections.

### BACKGROUND OF THE INVENTION

1. Technical Field

The present invention relates generally to the field of model or toy train sets and specifically to the field of accessories for tables designed for use with model or toy train sets.

2. Description of Prior Art

Model and toy train sets have provided entertainment to generations of enthusiasts as well as countless children. A model or toy train set typically seeks to emulate an actual railroad environment by providing a scale locomotive, rail cars, track, and associated scenery and accessories. Because the track system is generally fixed during play, a playing surface onto which track is placed is often desired. This playing surface is often incorporated into a table, thereby elevating the playing surface from the floor for more comfortable play.

Standard model train tables typically have raised vertical sides. This is especially prevalent when the model train table is used for toy train sets intended for children. The raised sides retain the small components of the model train set on the table top. However, such a model train table is limited in that the playing surface is restricted to a single level (the table top), unless complicated and expensive elevated track systems are used. While this may be acceptable to adult model train enthusiasts, it is often beyond the skill or desire of children. In addition, model train tables often lack appropriate scenery which would augment the play experience. Painting the sides of the model train table may solve this deficiency, but it results in a permanent and static solution which may eventually lead to boredom.

There is therefore a need for a system of accessories which can be used with a standard model train table to expand the playing area of the model train table and to also increase the variations of use and design available to users of model train tables.

It is therefore an objective of this invention to provide a system of accessories which can be used with a standard model train table to expand the playing area of the model train table without requiring any modifications to the model train table.

It is a further objective of this invention to provide a system of accessories which can be used with a model train table that can be used to easily vary the scenery used with the model train table.

It is yet a further objective of this invention to provide a system of accessories which can be used with a model train table that can provide multi-level placement of model train track.

It is yet a further objective of this invention to provide a system of accessories which can be used with a model train table that can be easily placed onto and taken off from the model train table, without use of tools.

It is yet a further objective of this invention to provide a system of accessories which can be used with a model train table that can easily connect multiple model train tables.

It is yet a further objective of this invention to provide a system of accessories which can be used with a model train table which are simple and inexpensive to manufacture.

Other objectives of this invention will be evident from the following disclosure.

### SUMMARY OF THE INVENTION

The system of accessories for use with a model train table of the present invention comprises a set of one or more removable perimeter sections suitably adapted to be placed over and onto the sides of a standard model train table to expand the usable surface play area and to provide variation in the placement and configuration of model train track. Each of these perimeter sections is suitably adapted to accommodate on its top surface a section of model train track, and on its inside surface a graphic design depicting appropriate scenery or other desired designs. Perimeter sections may be either straight sections or corner sections, and a complete system of accessories includes both types of perimeter sections. Portions of model train track on adjacent perimeter sections may be connected with each other, forming a continuous elevated model train track upon the multiple adjacent perimeter sections running about and above the perimeter of the model train table. Additionally, the portions of model train track may include spurs which may be connected to additional portions of model train track, connecting the portions of model train track on the perimeter sections with portions of model train track on the table surface of the model train table, or even with portions of model train track on other model train tables. So configured, the system of the present invention provides the user with an expanded playing area and easily changed sceneries. As used herein, the phrases “model train table” and “model train track” contemplate both highly sophisticated scale model systems as well as simple toy train sets enjoyed by young children.

Each perimeter section is comprised of a horizontal top member and two vertical panels depending downward from the top member. The inner and outer panels are oriented substantially parallel to each other and form a slot between them and under the top member. The perimeter section is placed onto a model train table by sliding it onto a side of the model train table, with the side of the model train table fitting snugly within the slot of the perimeter section. For increased stability, the width of the outer panel of the perimeter section may be made greater than the width of the inner panel. The top member may be adapted with a pair of spaced apart parallel rails running along its side edges, thereby forming a trough to better accommodate a portion of model train track. A graphic may be present on the outside surface of the perimeter section as well as on its inside surface, and the graphic may be formed onto a panel which is removably attached to the perimeter section, to allow for substitution of panels for greater variation in appearance. In the preferred embodiment the portion of model train track is fixedly attached to the top surface of the top member.

In one embodiment of the present invention a corner perimeter section may further comprise a platform affixed to the top member. This platform would be suitably adapted to support items associated with model train sets, such as model structures, trees, human figures, vehicles, and the like. Use of a platform extends the playing surface for the user.

Other features and advantages of the invention are described below.

### DESCRIPTION OF THE DRAWINGS

FIG. 1 is a perspective view of the system mounted onto a standard model train table.

FIG. 2 is a partial perspective view of the system partially mounted onto a standard model train table, with certain hidden portions depicted with ghost lines.

FIG. 3 is a perspective view of a perimeter section.

FIG. 4 is a perspective view of a corner perimeter section.

FIG. 5 is a perspective view of a perimeter section depicting the application of a graphic panel to the inner face of the inner panel.

FIG. 6 is an exploded perspective view of a perimeter section.

FIG. 7 is a perspective view of a perimeter section with a model train track having a spur, together with an additional model train track suitably adapted to be connected with the spur.

### DETAILED DESCRIPTION OF THE INVENTION

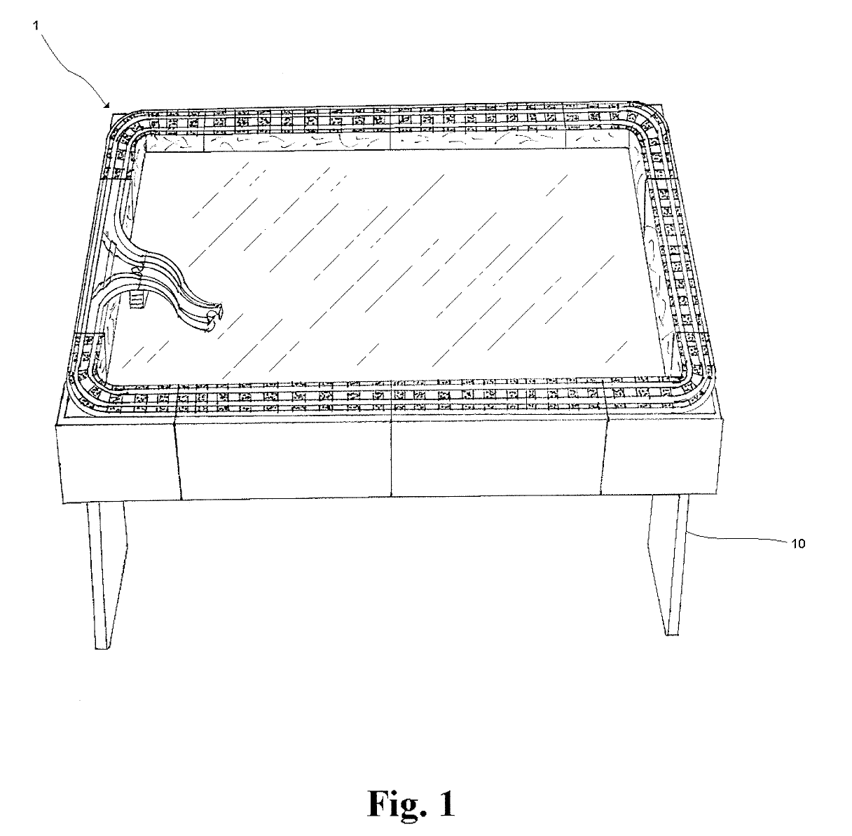

The present invention is a system of accessories 1 to be used with a model train table 10. The model train table 10 may be any standard table used for model or toy trains, so long as it is configured with a table top 12 oriented substantially horizontally and with one or more substantially planar side members 14 oriented substantially vertically and depending upward from the table top 12. The system 1 is adapted to be placed over and onto the side members 14 of the model train table 10 to extend the playing surface thereof and to increase the variability of play. See FIG. 1.

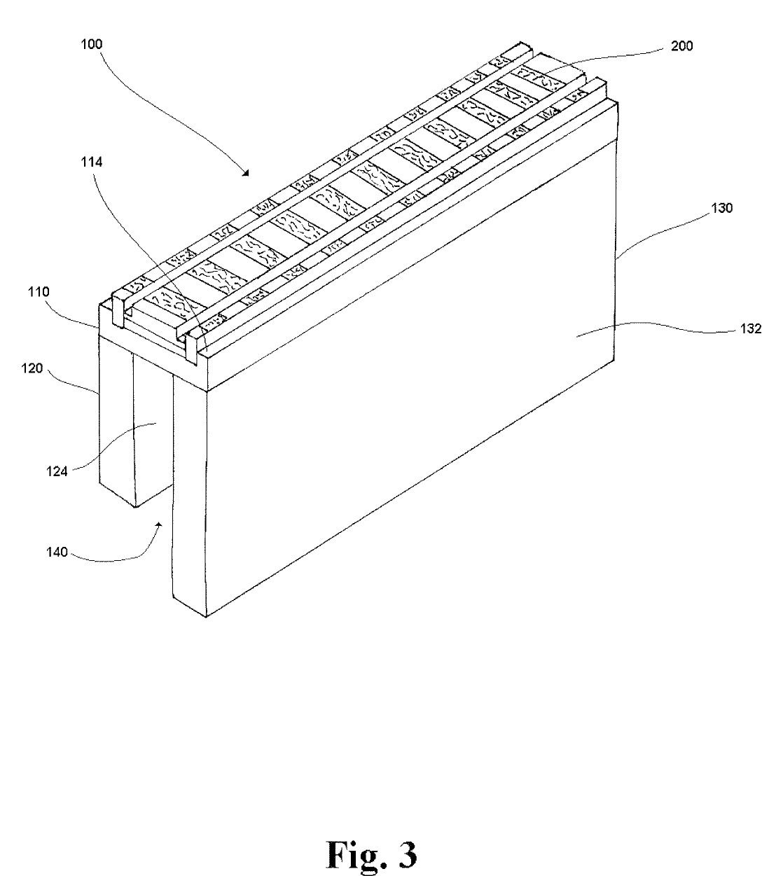

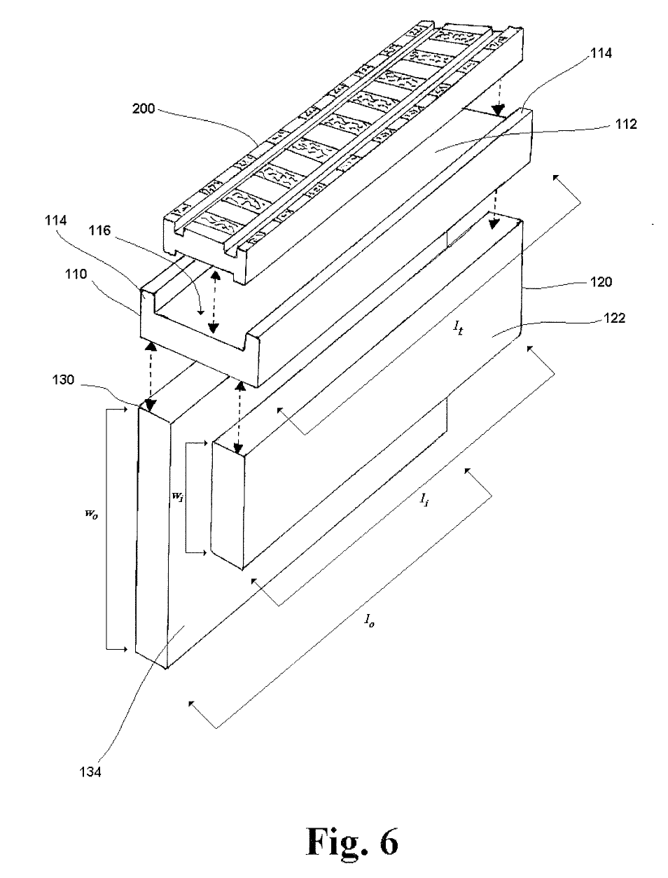

The system 1 comprises one or more perimeter sections 100. See FIG. 3. Each perimeter section 100 is comprised of a top member 110, an inner panel 120, and an outer panel 130. See FIGS. 3, 6. The top member 110 has a top surface 112 and a length lₜ. It is substantially planar. In the preferred embodiment it is rectangular in shape. In the most preferred embodiment it is constructed of wood, though other materials may be used, provided such materials are substantially rigid and sufficiently durable. Metal, alloys, injected-molded plastics, and the like may be used. The inner panel 120 has an outer face 122, an inner face 124, a length lᵢ, and a width wᵢ. It is substantially planar. The outer panel 130 has an outer face 132, an inner face 134, a length lₒ) and a width wₒ. It is substantially planar. In the preferred embodiment the inner panel 120 and the outer panel 130 are rectangular in shape. In the most preferred embodiment they are constructed of wood, though other materials as described above may be used. The lengths lₜ, lᵢ, lₒ of the top member 110, the inner panel 120, and the outer panel 130 are substantially the same. See FIG. 6.

The top member 110 of the perimeter section 100 is oriented substantially horizontally. The inner panel 120 of the perimeter section 100 is fixedly attached to the top member 110 and oriented substantially vertically, depending downward from the top member 110. The outer panel 130 of the perimeter section 100 is fixedly attached to the top member 110 and is likewise oriented substantially vertically, depending downward from the top member 110. The outer panel 130 is oriented substantially parallel to the inner panel 120 and is spaced apart from the inner panel 120, with the inner face 124 of the inner panel 120 oriented towards the inner face 134 of the outer panel 130. So configured, the top member 100, inner panel 120, and outer panel 130 form a slot 140, with the slot located below the top member 110 and between the inner faces 124,134 of the inner and outer panels 120,130. See FIG. 3. In the preferred embodiment, the width wₒ of the outer panel 130 of the perimeter section 100 is greater than the width wᵢ of the inner panel 120 of the perimeter section 100. See FIG. 6. This provides greater lateral stability during play.

The top member 110 is suitably adapted to accommodate the placing of a portion of model train track 200 upon its top surface 112. See FIG. 6. The model train track 200 may be a highly detailed scale model for use with electric trains, such as HO-scale track, or it may be toy wooden track such as the type manufactured by Brio™ for use by pre-school children. In one embodiment portions of model train track 200 may be removably placed onto the top surface 112, such that different model train track 200 may be used at different times, thereby increasing the variety of play. In the preferred embodiment the portion of model train track 200 is fixedly attached to the top surface 112 of the top member 110 of the perimeter section 100.

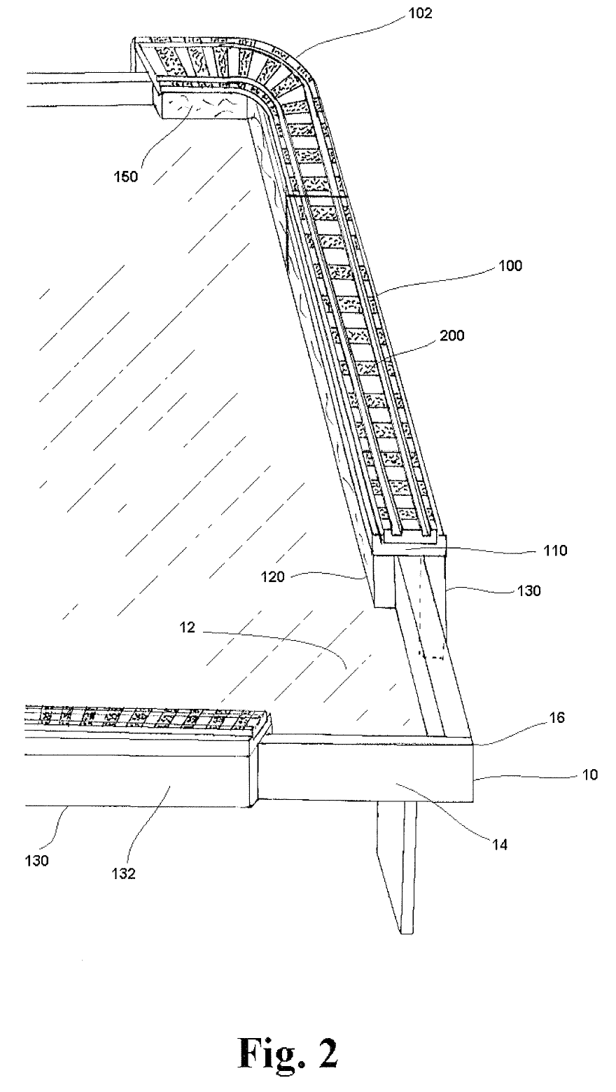

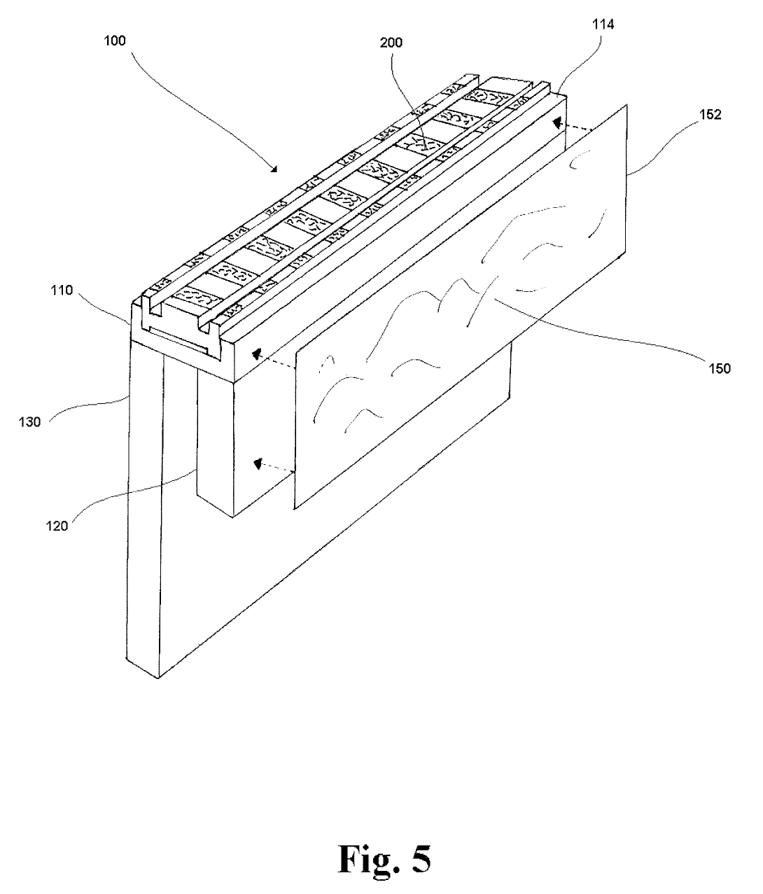

At least a portion of the outer face 122 of the inner panel 120 bears a graphic design 150. See FIG. 2. The graphic design 150 may be a drawing or a photograph or any other appropriate image, and it may reflect a realistic or a fanciful scene to enhance the play experience. The graphic design 150 may be in color or monochromatic. It may be applied directly to the outer face 122 of the inner panel 120 by ink, paint, paper or vinyl transfer, silk screen, or by any other suitable means known in the art. In one embodiment the graphic design 150 is formed onto a graphic panel 152. See FIG. 5. The graphic panel 152 may be rigid or flexible, durable or temporary, and may be constructed of wood, plastic, vinyl, paper, cloth, metal, or alloys. The graphic panel 152 is suitably adapted to be affixed to the outer face 122 of the inner panel 120. This may be accomplished by the use of magnets, hooks, adhesives, VELCRO™-style fasteners, nails, screws, tacks, and the like. In a preferred embodiment the graphic panel 152 is removably attached to the outer face 122 of the inner panel 120, thus allowing the user to alter the graphic design 150 to increase the variety of play.

In one embodiment at least a portion of the outer face 132 of the outer panel 130 of the perimeter section 100 bears a graphic design 150. A graphic panel 152 may be used for the outer face 132 of the outer panel 130 as well.

When used as intended, the perimeter section 100 is removably placed over and onto a portion of the side member 14 of the model train table 10, with the side member 14 fitting snugly within the slot 140. See FIG. 2. The inner face 124 of the inner panel 120 is adjacent to the inside surface of the side member 14 of the model train table 10, and the inner face 134 of the outer panel 130 is adjacent to the outside surface of the side member 14 of the model train table 10. The perimeter section 100 is placed so that the inner panel 120 is oriented towards the table top 12 of the model train table 10. The user is not limited as to where on the side members 14 of the model train table 10 the perimeter section 100 may be placed, with the user able to vary the placement of the perimeter section 100 as desired during play.

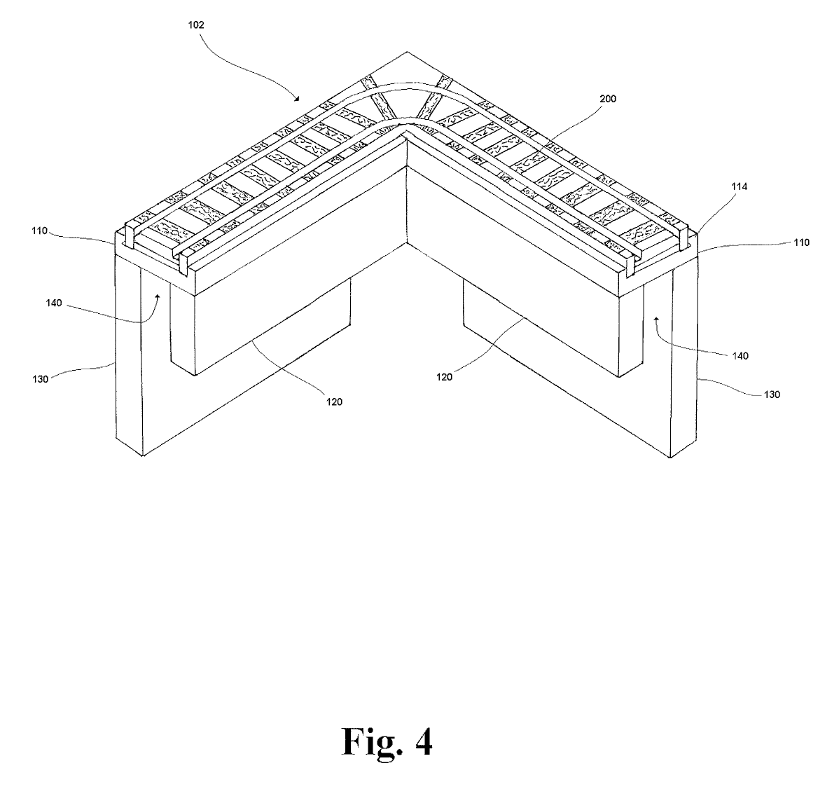

In one embodiment of the present invention, the perimeter section 100 is suitably adapted to fit over and onto a corner 16 of the model train table 10, where the corner 16 is formed by an adjacent pair of side members 14. See FIG. 2. In this embodiment, the inner panel 120 of the perimeter section 100 is substantially bi-planar, with the two planes thereof oriented substantially perpendicularly to each other, and the outer panel 130 of the perimeter section 100 is substantially bi-planar, with the two planes thereof oriented substantially perpendicularly to each other. See FIG. 4. One of the planar portions of the outer panel 130 remains oriented substantially parallel to one of the planar portions of the inner panel 120, while the other of the planar portions of the outer panel 130 remains oriented substantially parallel to the other of the planar portions of the inner panel 120. This configuration results in the formation of a slot 140 having a substantially ninety degree angle. The perimeter section 100 is placed over and onto the adjacent pair of side members 14 forming the corner 16 of the model train table 10, with the side members 14 fitting snugly within the slot 140 of the perimeter section 100. The inner panel 120 of the perimeter section 100 is oriented towards the table top 12 of the model train table 10. As with the straight perimeter section 100, the corner perimeter section described herein may bear a graphic design 150 on both its inner and outer panels 120,130, and may make use of graphic panels 152. Where graphic panels 152 are used, either they may be formed of a single piece of material, having a ninety degree bend, or they may be comprised of multiple sub-panels to be affixed to flat portions of the outer faces 122,132 of the inner and outer panels 120,130.

In an embodiment of the present invention contemplating the use of model train track 200 that is removable from the perimeter section 100, the top surface 112 of the top member 110 of the perimeter section 100 may comprise a pair of parallel, spaced apart rails 114. See FIG. 3. The rails 114 run along the length of the top member 110 on the edges thereof. The rails 114, in combination with the top surface 112, form a trough 116 which accommodates the portion of model train track 200 placed on the perimeter section 100. Use of the rails 114 minimizes inadvertent slipping of the model train track 200 from its desired position upon the top member 110 of the perimeter section 100. The rails 114 may be made of wood, plastic, metal, or any other material that is suitable for construction of the other elements of the perimeter section 100. In one embodiment the rails 114 are integrated with the top member 110. In another embodiment the rails 114 are formed of the top edges of the inner and outer panels 120,130. Where rails 114 are used on a corner perimeter section 102, the rails 114 each have a ninety degree bend. See FIG. 4.

In yet another embodiment of the present invention, the system 1 further comprises a platform. The platform is suitably adapted to be affixed to the top member 110 of a corner perimeter section 102. The platform is substantially planar but may have any desired perimeter configuration, either regular, such as circular or pentagonal, or irregular, with curves and contours. The platform is used to support associated items thereupon, such as model buildings associated with model trains, toy figures, landscape items, and the like. Portions of model train track 200 may be placed onto the platform, or special purpose features may be integrated therewith, for example, a model turntable for a platform configured as a roundhouse.

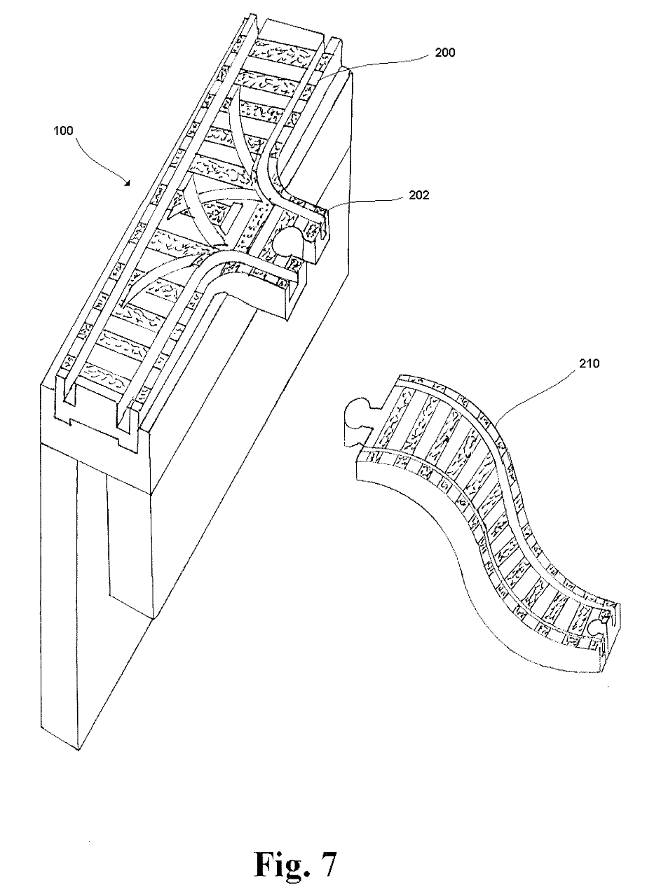

In the preferred embodiment, the system 1 comprises multiple perimeter sections 100, both straight and corner. In the most preferred embodiment the system 1 comprises four corner perimeter sections 102 and four or more straight perimeter sections 100. Such a set is sufficient to form a continuous elevated perimeter play surface around standard model train tables 10. See FIG. 1. When so used, portions of model train track 200 placed upon the top surfaces 112 of the perimeter sections 100 may be connected to each other to form a continuous perimeter track. Portions of model train track 200 may comprise spurs 202, allowing junctions with other portions of model train track 210. See FIG. 7. Thus, model train track 200 routes may be laid along the perimeter sections 100 and across the table top 12 in a continuous configuration, giving the user a multi-level playing experience. See FIG. 1. Additionally, the spurs 202 may be directed outward, permitting multiple model train tables 10 to be connected to each other, further extending the playing environment.

Modifications and variations may be made to the disclosed embodiments of the present invention without departing from the subject or spirit of the present invention as defined in the following claims.

I claim:

1. A system of accessories to be used with a model train table, said model train table having a table top oriented substantially horizontally and further having one or more substantially planar side members oriented substantially vertically and depending upward from said table top, said system comprising
a perimeter section, said perimeter section having
a top member, said top member having a top surface and a length,
an inner panel, said inner panel being substantially planar and having an outer face, an inner face, a length, and a width,
an outer panel, said outer panel being substantially planar and having an outer face, an inner face, a length, and a width, and
a slot;
wherein the top member of the perimeter section is oriented substantially horizontally and is suitably adapted to accommodate the placing of a portion of model train track upon the top surface of the top member,
the inner panel of the perimeter section is fixedly attached to the top member and oriented substantially vertically, depending downward from the top member,
the outer panel of the perimeter section is fixedly attached to the top member and is oriented substantially vertically, depending downward from the top member, and is oriented substantially parallel to the inner panel and spaced apart from the inner panel,
the inner face of the inner panel is oriented towards the inner face of the outer panel,
the slot of the perimeter section is formed between the inner panel and the outer panel and below the top member,
the lengths of the top member, the inner panel, and the outer panel are substantially the same, and
at least a portion of the outer face of the inner panel bears a graphic design;
whereby the perimeter section is suitably adapted to be removably placed over and onto at least a portion of a side member of the model train table, with said portion of the side member fitting within the slot of the perimeter section, and with the inner panel of the perimeter section oriented towards the table top of the model train table.

2. The system of claim 1 wherein the portion of model train track is fixedly attached to the top surface of the top member of the perimeter section.

3. The system of claim 1 wherein the graphic design is formed onto a graphic panel, said graphic panel suitably adapted to be affixed to the outer face of the inner panel.

4. The system of claim 1 wherein at least a portion of the outer face of the outer panel of the perimeter section bears a graphic design.

5. The system of claim 4 wherein the graphic design is formed onto a graphic panel, said graphic panel suitably adapted to be affixed to the outer face of the outer panel.

6. The system of claim 1 wherein the top surface of the top member of the perimeter section comprises a pair of parallel, spaced apart rails, said rails running along the length of the top member, said rails in combination with said top surface forming a trough suitably adapted to accommodate a portion of model train track.

7. The system of claim 1 wherein the width of the outer panel of the perimeter section is greater than the width of the inner panel of the perimeter section.

8. The system of claim 1 wherein the perimeter section is suitably adapted to fit over and onto a corner of the model train table formed by an adjacent pair of side members of the model train table,
with the inner panel of the perimeter section being substantially bi-planar, with the two planes thereof oriented substantially perpendicularly to each other,
the outer panel of the perimeter section being substantially bi-planar, with the two planes thereof oriented substantially perpendicularly to each other, with one of the planar portions of the outer panel oriented substantially parallel to one of the planar portions of the inner panel and the other of the planar portions of the outer panel oriented substantially parallel to the other of the planar portions of the inner panel, and
the slot having a substantially ninety degree angle;
whereby the perimeter section is suitably adapted to be placed over and onto at least a portion of each of the adjacent pair of side members forming the corner of the model train table, with said portions of the side members fitting within the slot of the perimeter section and the inner panel of the perimeter section oriented towards the table top of the model train table.

9. The system of claim 8 wherein the portion of model train track is fixedly attached to the top surface of the top member of the perimeter section.

10. The system of claim 8 wherein the graphic design is formed onto a graphic panel, said graphic panel suitably adapted to be affixed to the outer face of the inner panel.

11. The system of claim 8 wherein at least a portion of the outer face of the outer panel of the perimeter section bears a graphic design.

12. The system of claim 11 wherein the graphic design is formed onto a graphic panel, said graphic panel suitably adapted to be affixed to the outer face of the outer panel.

13. The system of claim 8 wherein the top surface of the top member of the perimeter section comprises a pair of spaced apart rails, said rails in combination with said top surface forming a trough suitably adapted to accommodate a portion of model train track.

14. The system of claim 8 further comprising a platform, said platform being suitably adapted to be affixed to the top member of the perimeter section, said platform being further suitably adapted to support associated items thereupon.

15. The system of claim 14 wherein the associated items are model structures associated with model trains.

16. The system of claim 8 wherein the width of the outer panel of the perimeter section is greater than the width of the inner panel of the perimeter section.

17. The system of claim 1 further comprising multiple perimeter sections, wherein pairs of the perimeter sections are placed adjacent to each other onto and upon at least one side member of the model train table,
whereby for each perimeter section a portion of model train track placed upon the top surface of the top member of said perimeter section may be connected to a portion of model train track placed upon the top surface of the top member of an adjacent perimeter section.

18. The system of claim 17 wherein for each of the multiple perimeter sections, the portion of model train track is fixedly attached to the top surface of the top member of said perimeter section.

19. The system of claim 17 wherein at least one perimeter section is a corner perimeter section, each said corner perimeter section suitably adapted to fit over and onto a corresponding corner of the model train table formed by an adjacent pair of side members of the model train table,
with the inner panel of each corner perimeter section being substantially bi-planar, with the two planes thereof oriented substantially perpendicularly to each other,
the outer panel of each corner perimeter section being substantially bi-planar, with the two planes thereof oriented substantially perpendicularly to each other, with one of the planar portions of said outer panel oriented substantially parallel to one of the planar portions of said inner panel and the other of the planar portions of said outer panel oriented substantially parallel to the other of the planar portions of said inner panel, and
the slot of each corner perimeter section having a substantially ninety degree angle;
whereby each corner perimeter section is suitably adapted to be placed over and onto at least a portion of each of the adjacent pair of side members forming the corresponding corner of the model train table, with said portions of the side members fitting within the slot of the corner perimeter section and the inner panel of the corner perimeter section oriented towards the table top of the model train table.

20. The system of claim 19 wherein for each corner perimeter section, the portion of model train track is fixedly attached to the top surface of the top member of said corner perimeter section.

21. The system of claim 19 wherein at least one perimeter section is not a corner perimeter section.

22. The system of claim 19 comprising at least eight perimeter sections, wherein four of the perimeter sections are corner perimeter sections and at least four of the perimeter sections are not corner perimeter sections.

23. The system of claim 1 wherein the perimeter section is constructed of wood.
